(19) United States
(12) Patent Application Publication
(10) Pub. No.: US 2025/0155257 A1
(43) Pub. Date: May 15, 2025

(54) VEHICLE CONTROL SYSTEMS FOR CAMERA-BASED VEHICLE NAVIGATION

(71) Applicant: GM GLOBAL TECHNOLOGY OPERATIONS LLC, Detroit, MI (US)

(72) Inventors: Ariel TELPAZ, Givat Haim Meuhad (IL); Nadav BARON, Hod Hasharon (IL); Alexander SHERMAN, Petah Tikva (IL); Refael BLANCA, West Bloomfield Township, MI (US); Michael BALTAXE, Kfar Saba (IL); Ron HECHT, Ra'anana (IL)

(21) Appl. No.: 18/508,818

(22) Filed: Nov. 14, 2023

(51) Int. Cl. G01C 21/36; G01C 21/34; G06V 10/25; G06V 10/70; G06V 20/56

(52) U.S. Cl. CPC G01C 21/3644; G01C 21/3476; G01C 21/3602; G01C 21/3647; G06V 10/25; G06V 10/70; G06V 20/56

(57) ABSTRACT

A vehicle control system for camera-based vehicle navigation includes at least one vehicle camera configured to capture an image of a front view from a vehicle, a global positioning system (GPS) receiver configured to obtain a current location of the vehicle, a vehicle user interface including a display, and a vehicle control module. The vehicle control module is configured to obtain the current location of the vehicle via the GPS receiver, identify a sequence of vehicle navigation steps to a target destination, capture the image via the at least one vehicle camera, process the image with a machine learning model to detect multiple objects in the image, rank the multiple objects according to landmark scoring criteria indicative of an object recognition likelihood by a driver of the vehicle, and display a highest ranked one of the multiple objects in association with a next vehicle navigation step.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to vehicle control systems for camera-based vehicle navigation, including image object detection for contextual vehicle navigation guidance.

Vehicle navigation systems generate a sequence of turns for a vehicle to travel from a current location to a target destination. The sequence of turns may be displayed on a user interface to alert a driver to upcoming turns based on a current location of the vehicle, as determined by a GPS system. The upcoming turns are generally associated with name of a road on which the vehicle should make a next left or right turn.

### SUMMARY

A vehicle control system for camera-based vehicle navigation includes at least one vehicle camera configured to capture an image of a front view from a vehicle, a global positioning system (GPS) receiver configured to obtain a current location of the vehicle, a vehicle user interface including a display, and a vehicle control module. The vehicle control module is configured to obtain the current location of the vehicle via the GPS receiver, identify a sequence of vehicle navigation steps from the current location of the vehicle to a target destination, capture the image of the front view of the vehicle via the at least one vehicle camera, process the image with a machine learning model to detect multiple objects in the image, rank the multiple objects according to landmark scoring criteria indicative of an object recognition likelihood by a driver of the vehicle, and display, on the vehicle user interface, a highest ranked one of the multiple objects in association with a next vehicle navigation step.

In other features, the vehicle control module is configured to record a turn action of the vehicle, compare a location of the turn action to the next vehicle navigation step to determine a turn compliance score indicative of whether the highest ranked one of the multiple objects was an accurate guidance landmark, and update the machine learning model via supervised learning, according to the turn compliance score.

In other features, the vehicle control module is configured to obtain a distance between the current location of the vehicle and the next vehicle navigation step, and process the image with a depth estimation model to generate a region of interest within the image, wherein the distance between the current location of the vehicle and the next vehicle navigation step lies within the region of interest of the image.

In other features, the vehicle control module is configured to detect the multiple objects in the image only within the region of interest.

In other features, the vehicle control module is configured to access a database to obtain multiple points of interest corresponding to the current location of the vehicle, and detect objects corresponding to the points of interest, within the region of interest of the image.

In other features, the vehicle control module is configured to, for each of the multiple points of interest, obtain an associated popularity score from the database, wherein the associated popularity score is indicative of a point of interest recognition level, and supply each associated popularity score to the machine learning model to facilitate ranking of the objects corresponding to the points of interest.

In other features, the vehicle control module is configured to process the image go generate a saliency map, the saliency map indicating a saliency level for each pixel of the image, and supply the saliency map to the machine learning model to facilitate ranking of the multiple detected objects.

In other features, the vehicle control module is configured to generate the saliency map by generating a red color saliency map which highlights pixels in the image corresponding to a red color, generating a blue color saliency map which highlights pixels in the image corresponding to a blue color, generating an intensity saliency map indicating an intensity level for each pixel in the image, generating a gabor saliency map corresponding to detection of straight lines in the image, and combining the red color saliency map, the blue color saliency map, the intensity saliency map and the gabor saliency map.

In other features, the vehicle control module is configured to divide the image into multiple segments via the machine learning model, crop a bounding box for each of the multiple segments, and transform each of the multiple segments into a text output via a large language machine learning model.

In other features, the vehicle control module is configured to generate a histogram of multiple terms according to the text output corresponding to each of the multiple segments, and select one of the multiple terms having a lowest frequency for display on the vehicle user interface in association with a next one of the sequence of vehicle navigation steps.

In other features, the vehicle control module is configured to, for each object of the multiple objects, perform optical character recognition to identify text associated with the object, compare the object to a database of stored logo data to determine whether the object has a matching logo, and obtain a confidence score from the machine learning model indicative of a detection confidence for the object.

In other features, the vehicle control module is configured to, for each of the multiple objects, generate a landmark score as a combination of a visibility score for the object, an intuitiveness score for the object, and a uniqueness score for the object.

A method of camera-based vehicle navigation includes obtaining a current location of a vehicle via a global positioning system (GPS) receiver of the vehicle, identifying a sequence of vehicle navigation steps from the current location of the vehicle to a target destination, capturing an image of a front view from the vehicle, via at least one vehicle camera, processing the image with a machine learning model to detect multiple objects in the image, ranking the multiple objects according to landmark scoring criteria indicative of an object recognition likelihood by a driver of the vehicle, and displaying, on a vehicle user interface, a highest ranked one of the multiple objects in association with a next vehicle navigation step.

In other features, the method includes recording a turn action of the vehicle, comparing a location of the turn action to the next vehicle navigation step to determine a turn compliance score indicative of whether the highest ranked one of the multiple objects was an accurate guidance landmark, and updating the machine learning model via supervised learning, according to the turn compliance score.

In other features, the method includes obtaining a distance between the current location of the vehicle and the next vehicle navigation step, and processing the image with a depth estimation model to generate a region of interest within the image, wherein the distance between the current location of the vehicle and the next vehicle navigation step lies within the region of interest of the image.

In other features, detecting the multiple objects includes detecting the multiple objects in the image only within the region of interest.

In other features, the method includes accessing a database to obtain multiple points of interest corresponding to the current location of the vehicle, and detecting objects corresponding to the points of interest, within the region of interest of the image.

In other features, the method includes, for each of the multiple points of interest, obtaining an associated popularity score from the database, wherein the associated popularity score is indicative of a point of interest recognition level, and supplying each associated popularity score to the machine learning model to facilitate ranking of the objects corresponding to the points of interest.

In other features, processing the image go generate a saliency map, the saliency map indicating a saliency level for each pixel of the image, and supplying the saliency map to the machine learning model to facilitate ranking of the multiple detected objects.

In other features, generating the saliency map includes generating a red color saliency map which highlights pixels in the image corresponding to a red color, generating a blue color saliency map which highlights pixels in the image corresponding to a blue color, generating an intensity saliency map indicating an intensity level for each pixel in the image, generating a gabor saliency map corresponding to detection of straight lines in the image, and combining the red color saliency map, the blue color saliency map, the intensity saliency map and the gabor saliency map.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example embodiment of a vehicle control system for camera-based vehicle navigation.

FIG. 2 is a flowchart depicting an example process for camera-based vehicle navigation, including image object detection for contextual vehicle navigation guidance.

FIG. 3 is a flowchart depicting an example process for using a depth estimation neural network to extract a relevant region of interest in a vehicle front camera image.

FIG. 4 is a flowchart depicting an example process for detecting objects in a vehicle front camera image.

FIG. 5 is flowchart depicting an example process for ranking detected objects in a vehicle front camera image.

FIG. 6 is flowchart depicting an example process for identifying patches in an image region of interest having an object probability above a specified threshold.

FIG. 7 is a diagram illustrating an example vehicle user interface displaying contextual vehicle navigation guidance.

FIGS. 8A and 8B are graphical representations of example recurrent neural networks for processing vehicle front camera images.

FIG. 9 is a graphical representation of layers of an example long short-term memory (LSTM) machine learning model.

FIG. 10 is a flowchart illustrating an example process for training a machine learning model.

In the drawings, reference numbers may be reused to identify similar and/or identical elements.

### DETAILED DESCRIPTION

Turn-by-turn navigation systems guide a driver to a desired destination by providing a simple set of instructions, which usually contain information about a whether to turn right or left, a street name for the next turn, and a distance to the next turn. users may fail to follow instructions due to incorrect distance estimation/perception, obscured signs, etc.

In some example embodiments, a computer vision based approach assists users in correctly implementing a navigation instruction, by associating the navigation instruction with spatial visual cues. The cues may be visual landmarks which are recognized in a scene in front of the vehicle, such as by using CV techniques with cameras mounted on the vehicle (e.g., “turn right after the [national fast food restaurant chain] sign”).

Machine learning techniques may be used to determine which objects are the most visible and intuitive visual landmarks to associate with a navigation instruction. In addition, some implementations may help drivers to better identify a destination location by associating it with distinguishable elements that are currently identified in the scene (e.g., “your destination is next to the [national hardware store chain] truck”). Example systems may be configured to use feedback from driver turn actions to improve models for identifying best landmark objects for contextual vehicle navigation guidance.

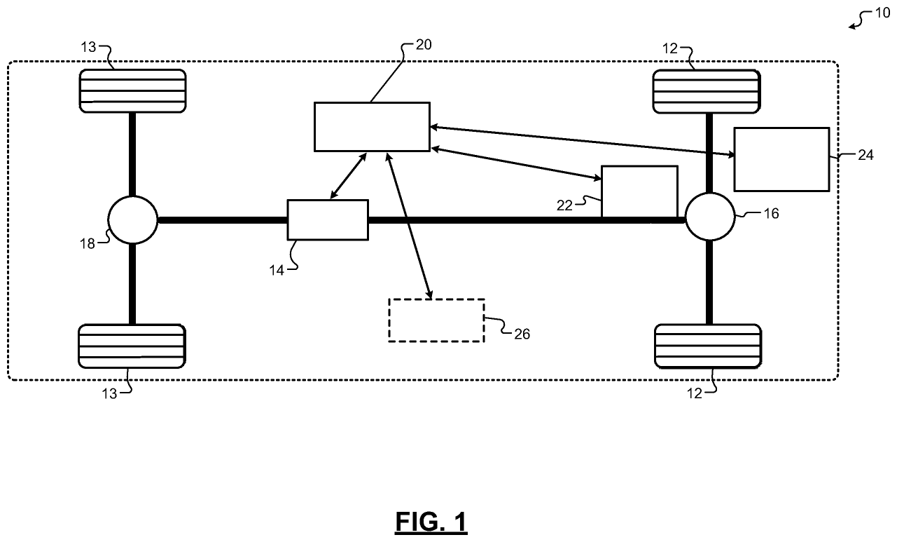

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration paddle, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as cameras, microphones, pressure sensors, wheel position sensors, location sensors such as global positioning system (GPS) antennas, etc.). Some sensors may be configured to monitor current motion of the vehicle, acceleration of the vehicle, steering torque, etc.

As shown in FIG. 1, the vehicle 10 includes a front vehicle camera 24 and an optional side vehicle camera 26. In various implementations, the vehicle 10 may include more or less of any one of these vehicle cameras (such as a rear vehicle camera, etc.). Each vehicle camera may include any suitable camera, laser, lidar sensor, etc., which is used to capture images around the vehicle 10 (such as a front vehicle camera image depicting a scene in front of the vehicle, etc.). In some example embodiments, a vehicle object detector may be configured to detect a closest in-path vehicle (CIPV) (e.g., another vehicle in front of a current driving path of the vehicle 10), a vulnerable road user (VRU) (e.g., a pedestrian or cyclist), etc.

The vehicle control module 20 may communicate with another device via a wireless communication interface, which may include one or more wireless antennas for transmitting and/or receiving wireless communication signals. For example, the wireless communication interface may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

The vehicle 10 also includes a user interface 22. The user interface 22 may include any suitable displays (such as on a dashboard, a console, or elsewhere), a touchscreen or other input devices, speakers for generation of audio, etc. In some example embodiments, the vehicle control module 20 may be configured to display vehicle navigation guidance on the user interface 22.

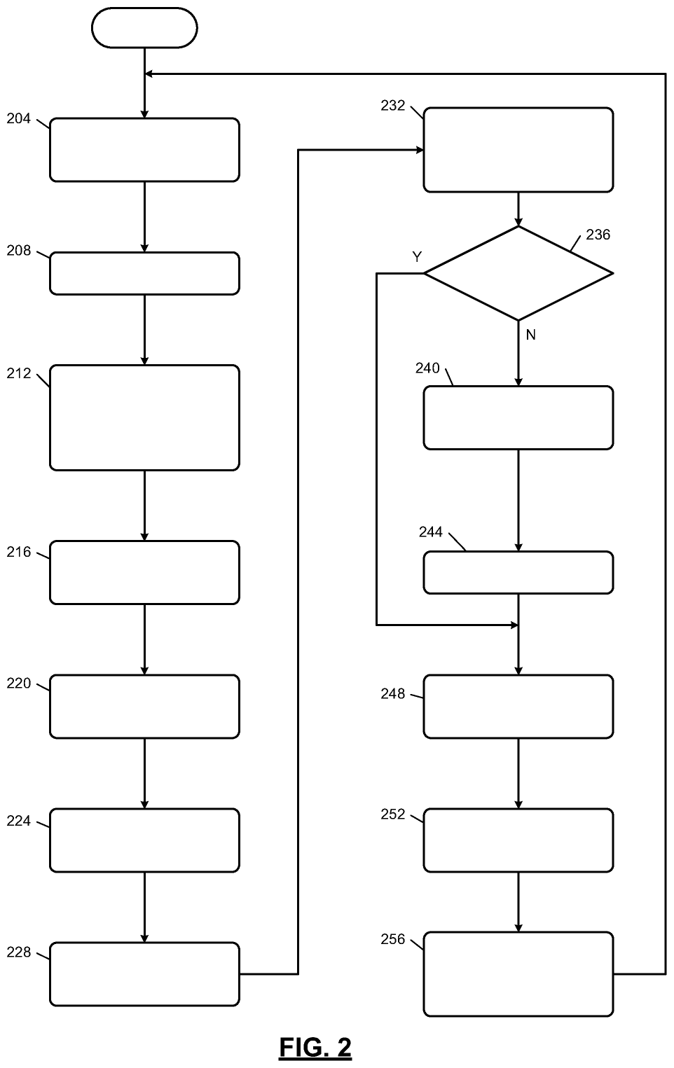

FIG. 2 is a flowchart depicting an example process for camera-based vehicle navigation, including image object detection for contextual vehicle navigation guidance. The process may be performed by, for example, the vehicle control module 20 of FIG. 1. At 204, the method begins by obtaining vehicle navigation instructions to a target destination, such as a sequence of turns and distances between turns for the vehicle 10 to travel from a current location to the target destination as determined by a GPS vehicle navigation system.

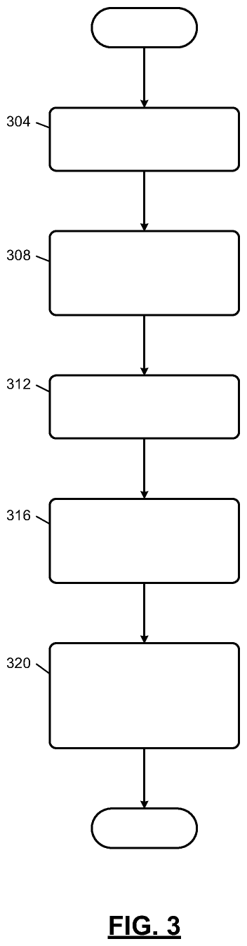

At 208, the vehicle control module is configured to obtain an image from the front vehicle camera, such as the front vehicle camera 24 of the vehicle 10 in FIG. 1. Although some example embodiments refer to images captured by a front vehicle camera, in some implementations images may be captured by a side vehicle camera, by a combination of one or more front and side vehicle cameras, etc. The vehicle control module then uses depth estimation to extract a relevant region of interest (ROI) based on the navigation instructions, at 212. Further details of using depth estimation are described further below with reference to FIG. 3.

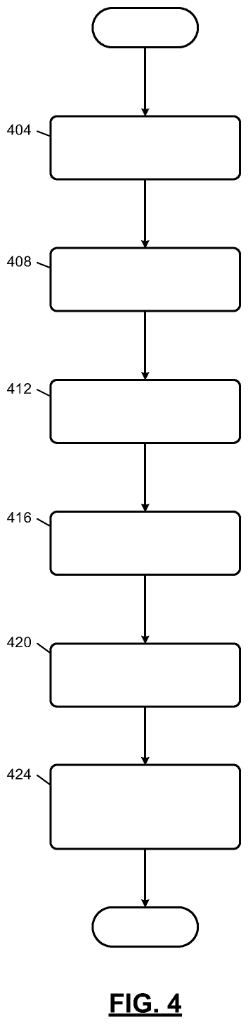

At 216, the vehicle control module is configured to detect recognized objects in the extracted region of interest. Further details regarding detecting objects in the ROI are described further below with reference to FIG. 4.

The control module is configured to obtain recognized landmarks at the current location of the vehicle from a database, at 220. For example, one or more databases may be configured to store various known landmarks at different locations. The vehicle control module may obtain a current location of the vehicle, and then access stored recognizable landmarks at the current vehicle location, from the database(s).

At 224, the vehicle control module is configured to obtain points of interest (POI) from a vehicle location map. For example, a vehicle navigation system may have stored points of interest associated with different locations, and the vehicle control module may obtain the points of interest that correspond to the current location of the vehicle.

The vehicle control module is configured to obtain points of interest popularity scores based on external metrics, at 228. For example, various rating systems, databases, etc., may store scores indicative of which points of interest have higher popularity for drivers, higher ratings or reviews for drivers, more frequent visits by drivers, etc.

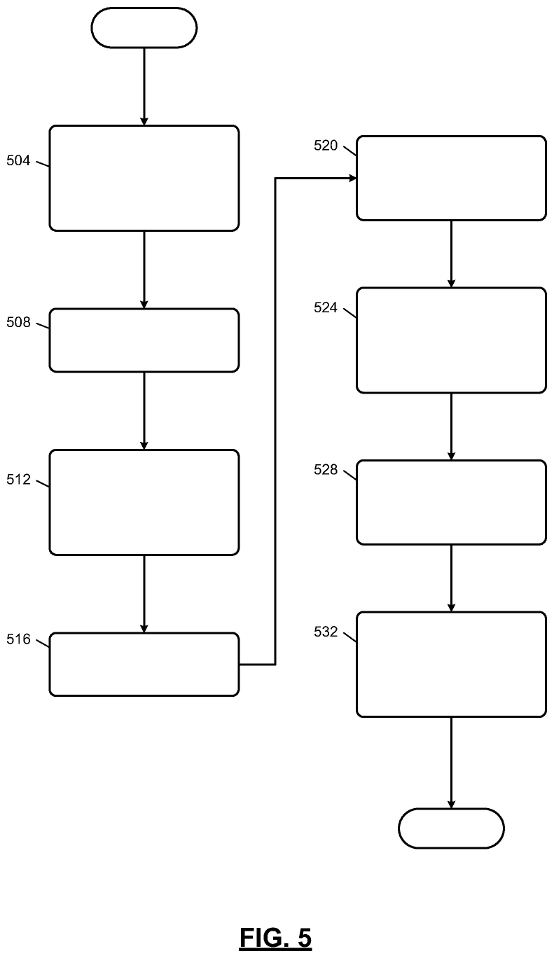

At 232, the vehicle control module is configured to rank the detected objects using image processing and additional metrics. For example, the vehicle control module may be configured to determine which objects detected in the front vehicle camera image are most likely to provide a most recognizable or identifiable landmark, to display for contextual driving navigation for the driver. Further details regarding an example ranking algorithm for detected objects are described further below with reference to FIG. 5.

The vehicle control module is configured to determine whether any relevant objects have been detected above a specified threshold, at 236. For example, a specified ranking threshold may be defined based on a landmark score determined for each object, such as a visibility of the object, recognition of the object, etc., which is indicative whether the object in the image would be a good candidate for display to a driver for contextual navigation guidance. If a detected object has a landmark score above a specified threshold, control proceeds to 248 to display the object, or one or more highest ranked objects of multiple objects above the threshold, on a vehicle user interface to provide the contextual driving navigation to the driver.

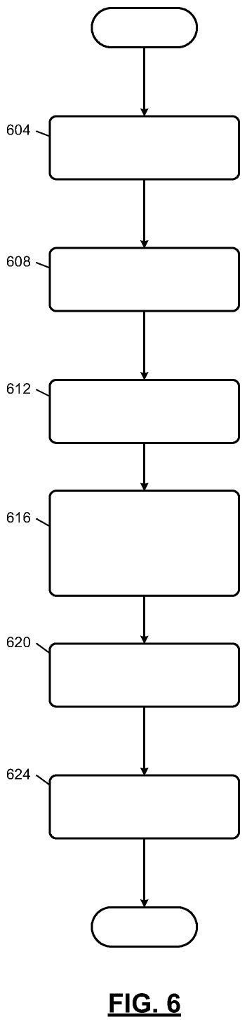

If control determines at 236 that no detected objects have a landmark or relevancy score above a specified threshold, control proceeds to 240 to identify patches in a region of interest of the image which have a high object probability. For example, if no objects are detected as having a sufficient match to known points of interest, or known recognized landmarks such as fast food restaurants or other widely known businesses, etc., control may perform image processing to identify general objects in the reason of interest of the image. Further details regarding identification of patches in the image are described further below with reference to FIG. 6.

At 244, the vehicle control module is configured to generate captions for identified likely objects. For example, a text conversion model may be applied to generate text descriptions such as car, tree, sign, etc., for portions of the image corresponding to detected objects. Control then displays the highest ranked objects and/or associated texts at 248.

At 252, the vehicle control module is configured to determine a driver action with respect to the displayed objects. For example, control may determine whether the driver followed a suggested turn prompt in the contextual driving navigation, whether the driver continued on past the identified landmark or turned too soon, etc. Control then provides feedback to update the object ranking algorithm based on the driver action, at 256.

In various implementations, each vehicle navigation instruction is followed by a driver's action. If the driver performs a wrong action (e.g., does not turn at a correct location), the system may use the information for improving a landmark score algorithm, such as by updating landmark selection model weights through supervised learning. In this manner, the algorithm may learn and continuously update the algorithm to identify which landmarks are more likely to be recognized and followed by drivers.

In some example embodiments, personal information which is learned from previous navigation destinations of the driver may be used to update a landmark scoring model for the driver. For example, if there is an object associated with a location which was visited by the driver frequently, the object may receive a higher score as a landmark candidate object as compared to locations that the driver visited less frequently.

FIG. 3 is a flowchart depicting an example process for using a depth estimation neural network to extract a relevant region of interest in a vehicle front camera image. At 304, the vehicle control module is configured to obtain an image from the front vehicle camera.

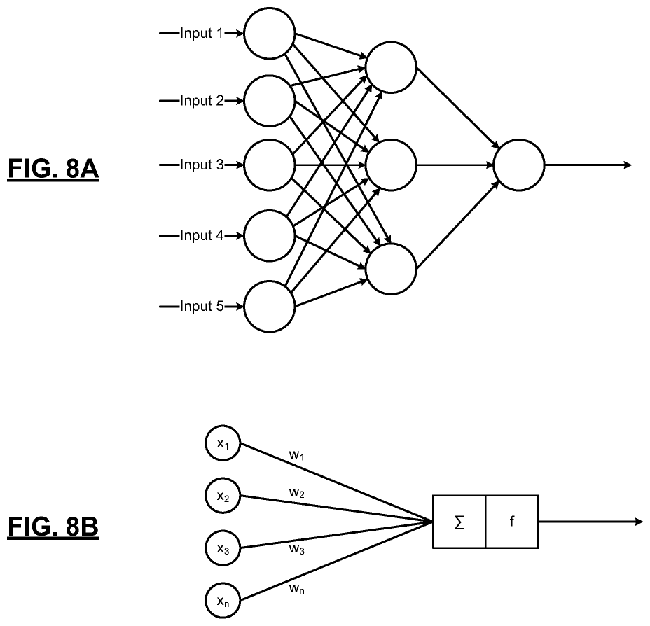

The vehicle control module then executes monocular depth estimation on the obtained image, such as via a trained neural network. For example, the neural network may identify locations in the image which are estimated to be within a specified distance range from a current location of the vehicle, such as between 75 meters to 125 meters ahead. This may be defined by focal points, such as identifying points in the image which are between a first focal point f1 and second focal point f2. Further details regarding example machine learning models are described further below with reference to FIGS. 8-10.

At 312, control is configured to obtain a next vehicle navigation action and a current vehicle location. For example, control may identify a next left or right turn in the sequence of navigation steps to the target destination, and also obtain a current location of the vehicle via a GPS system.

The vehicle control module is configured to determine a distance to the next navigation action based on the current vehicle location at 316. For example, control may obtain a distance to a road where the next left or right hand turn takes place. At 320, control may generate a window in the image that corresponds to the location of the next turn, such as the window that is 50 meters away, 100 meters away, 500 meters ahead, etc.

For example, control may perform depth masking on the obtained image based on the monocular depth estimation and the distance to the next navigation action, such as by excluding areas of the image which have a depth ‘D’ greater than a first distance or focal point f1 corresponding to a distance past the location of the next turn, and excluding areas of the image having a depth ‘D’ less than a second distance or focal point f2 in front of the location of the next turn.

FIG. 4 is a flowchart depicting an example process for detecting objects in a vehicle front camera image. At 404, the vehicle control module is configured to obtain a region of interest bounding box in an image captured by a front vehicle camera. Control then identifies segmented objects in the region of interest using a machine learning model, at 408. Further details of example machine learning models are described below with reference to FIGS. 8-10.

At 412, control compares objects in the region of interest to logos stored in one or more databases. For example, control may determine whether any of the determined objects are buildings or vehicles having logos which correspond to known businesses that would be identifiable by the driver.

The vehicle control module is configured to store matching logos identified in the image region of interest at 416. Control the proceeds to 420 to perform optical character recognition (OCR) on objects identified in the images of interest. For example, control may perform the OCR process to determine text associated with the detected objects in order to identify names of landmarks.

AT 424, control supplies the segmented objects, matched logos, and OCR results, to an object ranking algorithm. The object ranking algorithm may use the object segmentation, match logos, OCR results, etc., to determine which objects in the front vehicle camera image may provide the best landmark for displaying contextual vehicle navigation guidance to the driver.

FIG. 5 is flowchart depicting an example process for ranking detected objects in a vehicle front camera image. For example, the vehicle control module may select a best visual landmark from multiple candidate objects, to provide contextual vehicle navigation guidance to the driver. An example algorithm for scoring and ranking multiple detected candidate objects is described below.

At 504, the vehicle control module is configured to obtain a detection confidence score and other data for each detected object in the image region of interest. For example, the object detection model may provide a confidence score for each detected object, which is indicative of the likelihood that the model correctly identified the detected object. Control may also obtain any matched logos, OCR data, etc., which corresponds to each detected object.

At 508, control processes the image to generate a pixel saliency map. For example, salient objects are objects which are more noticeable to drivers according to their visual properties. Visibility of an object may be largely determined according to a saliency level of the object. If an object such as a pedestrian crossing sign has a higher saliency than a parked black car (e.g., as identified in an image processing saliency map where brighter areas are more salient), a contextual navigation display may indicate “turn right before the pedestrian crossing sign” as opposed to “turn just before the black parked car.”

In some example embodiments, a saliency map may be generated by combining a set of known salient features. For example, a saliency map may be generated by combining separate image processing maps configured to highlight red color in the image, to highlight blue color, to highlight levels of intensity in the image, and to highlight levels of gabor (e.g., detection of straight lines in the image), etc.

At 512, the vehicle control module is configured to assign a visibility score to each object based on the saliency map, the detection confidence, and object occlusion. The visibility score may indicate the ability of the object to capture a driver's attention. For example, control may use the saliency map, confidence scores for detected objects, an indication of whether an object is partially or totally obscured from a driver's view, etc., in order to determine how visible the object will be to the driver as they drive along the road.

At 516, the vehicle control module is configured to obtain text and logo data associated with the detected objects. Control then proceeds to 520 to assign an intuitiveness score each object based on the text and/or logo data associated with the object. The intuitiveness score may be indicative of whether there are elements in the detected object which make it easier for the driver to understand, such as text, familiar logos, traffic lights, traffic signs, etc. For example, if a well-known logo or text is associated with an object, it may receive a higher score as being intuitively recognizable by the driver.

The vehicle control module is compared to determine a relative occurrence of each object in an image ROI, as compared to objects of the entire image, at 524. Control may determine whether there are multiple versions of similar type in the image, or wither an object is unique as compared to other object types in the scene.

At 528, control assigns a uniqueness score each object based on the determined relative occurrences in the image. The uniqueness score may be indicative of whether the type of object (e.g., black car) occurs in other locations in the scene. For example, if a type of building is identified as the only building in the scene, a high uniqueness score may be assigned as compared to a detected black vehicle where there are multiple other black vehicles within the scene.

At 532, control assigns a landmark score to each object. The landmark score may be a weighted combination of the visibility score, uniqueness score, and intuitiveness score, which were previously determined for an object. The landmark score may be indicative of a likelihood that the driver will be able to clearly and quickly recognize the object as a landmark to use for contextual vehicle navigation guidance.

FIG. 6 is flowchart depicting an example process for identifying patches in an image region of interest having an object probability above a specified threshold. At 604, the vehicle control module is configured to divide the image region of interest into segments. Control then crops a bounding box for each segment in the image region of interest, at 608.

At 612, control transforms each image segment into text via a large language model (e.g., a CLIP model). For example, a machine learning module may be configured to determine textual words corresponding to common objects, such as tree, sidewalk, road, no-right turn sign, wall, pole, etc. Text embeddings may be obtained by processing a specified number of most common nouns in English (or other desired language).

At 616, the vehicle control module is configured to create a histogram of nouns in the scene, and normalize each category by its area in the image. Control may remove non-informative objects (e.g., “road”) in order to focus a list on unique objects in the scene which the driver would be able to recognize more easily.

Control selects an object having a smallest instance count, and a largest area, at 620. For example, control may identify an object having a large size in the image, where the object is also the only one of its kind in the image (such as the only traffic sign). Selecting a large and unique object makes it easier for a driver to recognize the selected object, to provide better contextual navigation guidance. Control then supplies the identified object for display on a vehicle user interface at 624, so the driver knows which landmark object to watch out for in order to know when to make a next turn.

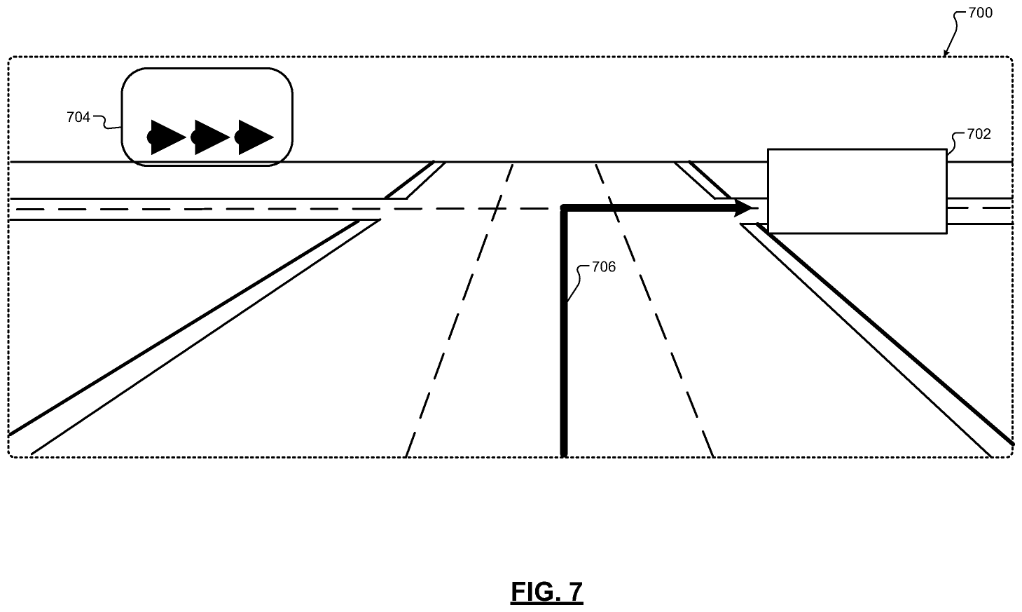

FIG. 7 is a diagram illustrating an example of a vehicle user interface 700 for displaying contextual vehicle navigation guidance. As shown in FIG. 7, the vehicle user interface 700 displays contextual navigation guidance 706, which includes a right turn arrow display to identify a landmark object 702 such as a fast food restaurant, for making a next navigational turn (e.g., to reach a target destination).

The textual navigation guidance may include a text prompt 704 which alerts the driver of the upcoming landmark object 702 for the next navigational turn, such as stating “turn right after fast food restaurant” (e.g., when a fast food restaurant having a known logo is identified as the landmark object 702, etc.).

FIGS. 8A and 8B show an example of a recurrent neural network used to generate models such as those described above, using machine learning techniques. Machine learning is a method used to devise complex models and algorithms that lend themselves to prediction (for example, patient and provider matching predictions). The models generated using machine learning, such as those described above, can produce reliable, repeatable decisions and results, and uncover hidden insights through learning from historical relationships and trends in the data.

The purpose of using the recurrent neural-network-based model, and training the model using machine learning as described above, may be to directly predict dependent variables without casting relationships between the variables into mathematical form. The neural network model includes a large number of virtual neurons operating in parallel and arranged in layers. The first layer is the input layer and receives raw input data. Each successive layer modifies outputs from a preceding layer and sends them to a next layer. The last layer is the output layer and produces output of the system.

FIG. 8A shows a fully connected neural network, where each neuron in a given layer is connected to each neuron in a next layer. In the input layer, each input node is associated with a numerical value, which can be any real number. In each layer, each connection that departs from an input node has a weight associated with it, which can also be any real number (see FIG. 8B). In the input layer, the number of neurons equals number of features (columns) in a dataset. The output layer may have multiple continuous outputs.

The layers between the input and output layers are hidden layers. The number of hidden layers can be one or more (one hidden layer may be sufficient for most applications). A neural network with no hidden layers can represent linear separable functions or decisions. A neural network with one hidden layer can perform continuous mapping from one finite space to another. A neural network with two hidden layers can approximate any smooth mapping to any accuracy.

The number of neurons can be optimized. At the beginning of training, a network configuration is more likely to have excess nodes. Some of the nodes may be removed from the network during training that would not noticeably affect network performance. For example, nodes with weights approaching zero after training can be removed (this process is called pruning). The number of neurons can cause under-fitting (inability to adequately capture signals in dataset) or over-fitting (insufficient information to train all neurons; network performs well on training dataset but not on test dataset).

Various methods and criteria can be used to measure performance of a neural network model. For example, root mean squared error (RMSE) measures the average distance between observed values and model predictions. Coefficient of Determination (R2) measures correlation (not accuracy) between observed and predicted outcomes. This method may not be reliable if the data has a large variance. Other performance measures include irreducible noise, model bias, and model variance. A high model bias for a model indicates that the model is not able to capture true relationship between predictors and the outcome. Model variance may indicate whether a model is stable (a slight perturbation in the data will significantly change the model fit). The neural network can receive inputs, e.g., vectors, which can be used to generate models that can be used with provider matching, risk model processing, or both, as described herein.

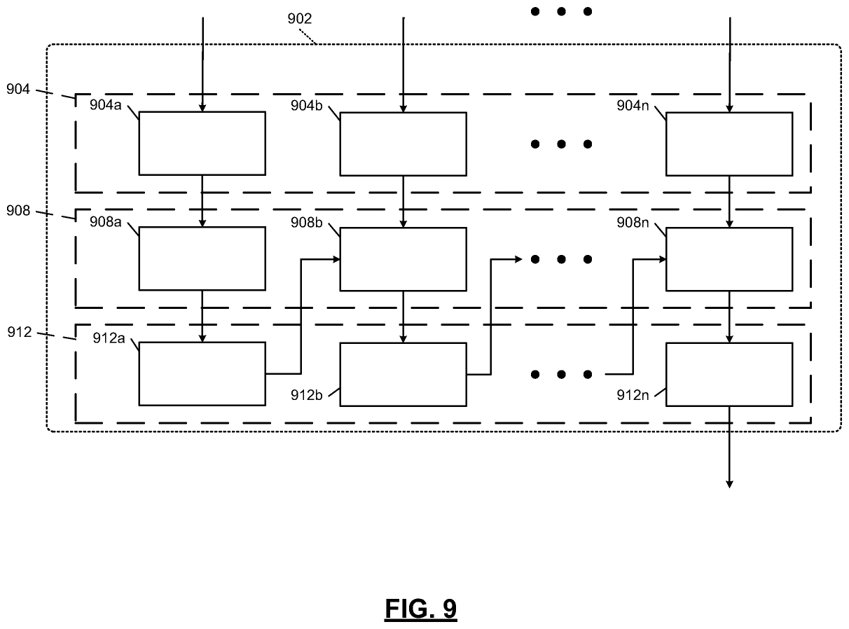

FIG. 9 illustrates an example of a long short-term memory (LSTM) neural network 902 used to generate models such as those described above, using machine learning techniques, although other example embodiments may include other types of machine learning models including transformer layers, other model topologies, etc. The generic example LSTM neural network 902 may be used to implement a machine learning model, and various implementations may use other types of machine learning networks (such as transformer layers, other model topologies or architectures, etc.). The LSTM neural network 902 includes an input layer 904, a hidden layer 908, and an output layer 912. The input layer 904 includes inputs 904a, 904b . . . 904n. The hidden layer 908 includes neurons 908a, 908b . . . 908n. The output layer 912 includes outputs 912a, 912b . . . 912n.

Each neuron of the hidden layer 908 receives an input from the input layer 904 and outputs a value to the corresponding output in the output layer 912. For example, the neuron 908a receives an input from the input 904a and outputs a value to the output 912a. Each neuron, other than the neuron 908a, also receives an output of a previous neuron as an input. For example, the neuron 908b receives inputs from the input 904b and the output 912a. In this way the output of each neuron is fed forward to the next neuron in the hidden layer 908. The last output 912n in the output layer 912 outputs a probability associated with the inputs 904a-904n. Although the input layer 904, the hidden layer 908, and the output layer 912 are depicted as each including three elements, each layer may contain any number of elements.

In various implementations, each layer of the LSTM neural network 902 must include the same number of elements as each of the other layers of the LSTM neural network 902. In some example embodiments, a convolutional neural network may be implemented. Similar to LSTM neural networks, convolutional neural networks include an input layer, a hidden layer, and an output layer. However, in a convolutional neural network, the output layer includes one less output than the number of neurons in the hidden layer and each neuron is connected to each output. Additionally, each input in the input layer is connected to each neuron in the hidden layer. In other words, input 904a is connected to each of neurons 908a, 908b . . . 908n.

In various implementations, each input node in the input layer may be associated with a numerical value, which can be any real number. In each layer, each connection that departs from an input node has a weight associated with it, which can also be any real number. In the input layer, the number of neurons equals number of features (columns) in a dataset. The output layer may have multiple continuous outputs.

As mentioned above, the layers between the input and output layers are hidden layers. The number of hidden layers can be one or more (one hidden layer may be sufficient for many applications). A neural network with no hidden layers can represent linear separable functions or decisions. A neural network with one hidden layer can perform continuous mapping from one finite space to another. A neural network with two hidden layers can approximate any smooth mapping to any accuracy. The neural network of FIG. 9 can receive inputs, e.g., vectors, that can be used to generate models that can be used with vehicle camera images for generating pedestrian crossing intention prediction outputs, as described herein.

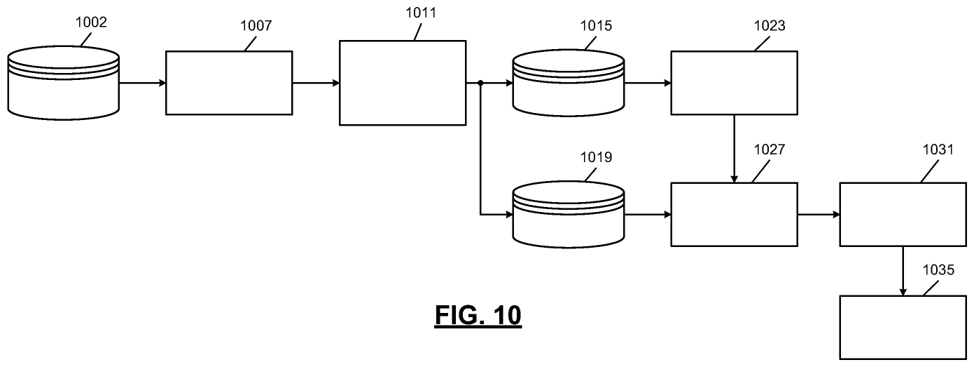

FIG. 10 illustrates an example process for generating a machine learning model. At 1007, control obtains data from a database 1002 (e.g., a data warehouse). The data may include any suitable data for developing machine learning models.

At 1011, control separates the data obtained from the database 1002 into training data 1015 and test data 1019. The training data 1015 is used to train the model at 1023, and the test data 1019 is used to test the model at 1027. Typically, the set of training data 1015 is selected to be larger than the set of test data 1019, depending on the desired model development parameters. For example, the training data 1015 may include about seventy percent of the data acquired from the database 1002, about eighty percent of the data, about ninety percent, etc. The remaining thirty percent, twenty percent, or ten percent, is then used as the test data 1019.

Separating a portion of the acquired data as test data 1019 allows for testing of the trained model against actual output data, to facilitate more accurate training and development of the model at 1023 and 1027. The model may be trained at 1023 using any suitable machine learning model techniques, including those described herein, such as random forest, generalized linear models, decision tree, and neural networks.

At 1031, control evaluates the model test results. For example, the trained model may be tested at 1027 using the test data 1019, and the results of the output data from the tested model may be compared to actual outputs of the test data 1019, to determine a level of accuracy. The model results may be evaluated using any suitable machine learning model analysis, such as the example techniques described further below.

After evaluating the model test results at 1031, the model may be deployed at 1035 if the model test results are satisfactory. Deploying the model may include using the model to make predictions for a large-scale input dataset with unknown outputs. If the evaluation of the model test results at 1031 is unsatisfactory, the model may be developed further using different parameters, using different modeling techniques, using other model types, etc. The machine learning model method of FIG. 10 can receive inputs, e.g., vectors, which can be used to generate models that can be used with image processing, object detection, etc., as described herein.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle control system for camera-based vehicle navigation, the vehicle control system comprising:
at least one vehicle camera configured to capture an image of a front view from a vehicle;
a global positioning system (GPS) receiver configured to obtain a current location of the vehicle;
a vehicle user interface including a display; and
a vehicle control module configured to:
obtain the current location of the vehicle via the GPS receiver;
identify a sequence of vehicle navigation steps from the current location of the vehicle to a target destination;
capture the image of the front view of the vehicle via the at least one vehicle camera;
process the image with a machine learning model to detect multiple objects in the image;
rank the multiple objects according to landmark scoring criteria indicative of an object recognition likelihood by a driver of the vehicle; and
display, on the vehicle user interface, a highest ranked one of the multiple objects in association with a next vehicle navigation step.

2. The vehicle control system of claim 1, wherein the vehicle control module is configured to:
record a turn action of the vehicle;
compare a location of the turn action to the next vehicle navigation step to determine a turn compliance score indicative of whether the highest ranked one of the multiple objects was an accurate guidance landmark; and
update the machine learning model via supervised learning, according to the turn compliance score.

3. The vehicle control system of claim 1, wherein the vehicle control module is configured to:
obtain a distance between the current location of the vehicle and the next vehicle navigation step; and
process the image with a depth estimation model to generate a region of interest within the image, wherein the distance between the current location of the vehicle and the next vehicle navigation step lies within the region of interest of the image.

4. The vehicle control system of claim 3, wherein the vehicle control module is configured to detect the multiple objects in the image only within the region of interest.

5. The vehicle control system of claim 3, wherein the vehicle control module is configured to:
access a database to obtain multiple points of interest corresponding to the current location of the vehicle; and
detect objects corresponding to the points of interest, within the region of interest of the image.

6. The vehicle control system of claim 5, wherein the vehicle control module is configured to:
for each of the multiple points of interest, obtain an associated popularity score from the database, wherein the associated popularity score is indicative of a point of interest recognition level; and
supply each associated popularity score to the machine learning model to facilitate ranking of the objects corresponding to the points of interest.

7. The vehicle control system of claim 1, wherein the vehicle control module is configured to:
process the image go generate a saliency map, the saliency map indicating a saliency level for each pixel of the image; and
supply the saliency map to the machine learning model to facilitate ranking of the multiple detected objects.

8. The vehicle control system of claim 7, wherein the vehicle control module is configured to generate the saliency map by:
generating a red color saliency map which highlights pixels in the image corresponding to a red color;
generating a blue color saliency map which highlights pixels in the image corresponding to a blue color;
generating an intensity saliency map indicating an intensity level for each pixel in the image;
generating a gabor saliency map corresponding to detection of straight lines in the image; and
combining the red color saliency map, the blue color saliency map, the intensity saliency map and the gabor saliency map.

9. The vehicle control system of claim 1, wherein the vehicle control module is configured to:
divide the image into multiple segments via the machine learning model;
crop a bounding box for each of the multiple segments; and
transform each of the multiple segments into a text output via a large language machine learning model.

10. The vehicle control system of claim 9, wherein the vehicle control module is configured to:
generate a histogram of multiple terms according to the text output corresponding to each of the multiple segments; and
select one of the multiple terms having a lowest frequency for display on the vehicle user interface in association with a next one of the sequence of vehicle navigation steps.

11. The vehicle control system of claim 1, wherein the vehicle control module is configured to, for each object of the multiple objects:
perform optical character recognition to identify text associated with the object;
compare the object to a database of stored logo data to determine whether the object has a matching logo; and
obtain a confidence score from the machine learning model indicative of a detection confidence for the object.

12. The vehicle control system of claim 11, wherein the vehicle control module is configured to, for each of the multiple objects, generate a landmark score as a combination of a visibility score for the object, an intuitiveness score for the object, and a uniqueness score for the object.

13. A method of camera-based vehicle navigation, the method comprising:
obtaining a current location of a vehicle via a global positioning system (GPS) receiver of the vehicle;
identifying a sequence of vehicle navigation steps from the current location of the vehicle to a target destination;
capturing an image of a front view from the vehicle, via at least one vehicle camera;
processing the image with a machine learning model to detect multiple objects in the image;
ranking the multiple objects according to landmark scoring criteria indicative of an object recognition likelihood by a driver of the vehicle; and
displaying, on a vehicle user interface, a highest ranked one of the multiple objects in association with a next vehicle navigation step.

14. The method of claim 13, further comprising:
recording a turn action of the vehicle;
comparing a location of the turn action to the next vehicle navigation step to determine a turn compliance score indicative of whether the highest ranked one of the multiple objects was an accurate guidance landmark; and
updating the machine learning model via supervised learning, according to the turn compliance score.

15. The method of claim 13, further comprising:
obtaining a distance between the current location of the vehicle and the next vehicle navigation step; and
processing the image with a depth estimation model to generate a region of interest within the image, wherein the distance between the current location of the vehicle and the next vehicle navigation step lies within the region of interest of the image.

16. The method of claim 15, wherein detecting the multiple objects includes detecting the multiple objects in the image only within the region of interest.

17. The method of claim 15, further comprising:
accessing a database to obtain multiple points of interest corresponding to the current location of the vehicle; and
detecting objects corresponding to the points of interest, within the region of interest of the image.

18. The method of claim 17, further comprising:
for each of the multiple points of interest, obtaining an associated popularity score from the database, wherein the associated popularity score is indicative of a point of interest recognition level; and
supplying each associated popularity score to the machine learning model to facilitate ranking of the objects corresponding to the points of interest.

19. The method of claim 13, further comprising:
processing the image go generate a saliency map, the saliency map indicating a saliency level for each pixel of the image; and
supplying the saliency map to the machine learning model to facilitate ranking of the multiple detected objects.

20. The method of claim 19, wherein generating the saliency map includes:
generating a red color saliency map which highlights pixels in the image corresponding to a red color;
generating a blue color saliency map which highlights pixels in the image corresponding to a blue color;
generating an intensity saliency map indicating an intensity level for each pixel in the image;
generating a gabor saliency map corresponding to detection of straight lines in the image; and
combining the red color saliency map, the blue color saliency map, the intensity saliency map and the gabor saliency map.
